(19) United States
(12) Patent Application Publication
(10) Pub. No.: US 2010/0094471 A1
(43) Pub. Date: Apr. 15, 2010

(54) CONTROL SYSTEM

(75) Inventor: Patrick A. LOWERY, Greer, SC (US)

Correspondence Address: MCNEES WALLACE & NURICK LLC, 100 PINE STREET, P.O. BOX 1166, HARRISBURG, PA, 17108-1166, US

(73) Assignee: CIRCOR INSTRUMENTATION TECHNOLOGIES, INC., Spartanburg, SC (US)

(21) Appl. No.: 12/578,408

(22) Filed: Oct. 13, 2009

Related U.S. Application Data
(60) Provisional application No. 61/105,196, filed on Oct. 14, 2008.

(51) Int. Cl. G05D 7/06

(52) U.S. Cl. 700/282

(57) ABSTRACT

A control system receives control information generated from reference information received from system sensors of physical parameters. The control system uses the information to control a plurality of control devices. The control system has a second control unit which receives and processes the control information and generates control device output, indicating which control device should be operated. A plurality of physical switches are provided, each of the switches represents one of the plurality of control devices. A first group of selected switches are closed and a second group of nonselected switches are open. A logic array receives the control device output and compares the control device output with the first group of selected switches or the second group of nonselected switches and generates appropriate valve operation outputs.

### FIELD OF THE INVENTION

The present invention is directed to a control system. In particular, the control system has physical switches which prevent unsafe sequences from occurring.

### BACKGROUND OF THE INVENTION

In recent years microprocessor control systems have been used to control machines and systems because they are inexpensive and flexible. When safety aspects have to be considered such as in environmentally hazardous applications, such as burner control systems, nuclear systems or chemical mixing systems, inbuilt software routines are used to help detect fault conditions in the systems they are controlling. However, such systems can be subject to unpredictable failure modes because of the integral microprocessor control and so leave an element of doubt when used for safety critical applications.

U.S. Pat. No. 5,063,527 discloses a monitor system for safety critical situations such as burner control. The monitor system receives control information from a programmable logic controller (“PLC”) and reference information from plant interlocks. This information passes via opto-isolators and buffers to the address bus of an erasable programmable read only memory (“EPROM”) so as to access information stored therein which normally mirrors the PLC information so as to control relays via drivers to conform to the PLC instructions. The EPROM also contains reset and clock information for use by a counter which allows different areas within the EPROM to be accessed. The reset information is also available to a parity check circuit via oscillator for dynamically testing the monitor for integrity of operation. Failure of the PLC or monitor components will cause access to shutdown addresses of the EPROM and operation of the appropriate relays including a lockout relay.

U.S. Pat. No. 5,063,527 provides safety checks which are all done with the use of software. As even redundant software is subject to failure modes and incorrect programming, it would be beneficial to provide physical failsafe gates or switches, which are not subject to electrical or software failure and which can be observed and programmed by the skilled personnel at the facility to prevent harmful sequences from occurring.

### SUMMARY OF THE INVENTION

According to one aspect of the invention there is provided a control system which receives control information. The information may be received from a controller. The control information is generated from reference information received from system sensors of physical parameters. The control system uses the information to control a plurality of control devices.

The control system has a control unit which receives and processes the control information and generates control device output, indicating which control devices should be operated. A plurality of physical switches are provided, each of the switches represents one of the plurality of control devices. A first group of selected switches are closed and a second group of nonselected switches are open. A logic array receives the control device output and compares the control device output with the first group of selected switches or the second group of nonselected switches and generates appropriate valve operation outputs.

If the control device output indicates that at least one control device associated with the first group of switches and at least one control device associated with the second group of switches are to be engaged at the same time, the logic array will not send the control device operation output to the control devices, but will send an error message to the control unit. Under these circumstances, the logic array may remain at the last valid setting. Alternatively, if the control device output indicates that only control devices associated with the first group of switches or only control devices associated with the second group of switches are to be engaged at the same time, the logic array will send the control device output to the control devices.

The second control unit is may be a microprocessor. The control devices may be valves.

The control system disclosed herein has many advantages. Several of these advantages relate to safety. As the switches are physical, hardware switches, a power surge, etc. will not cause the failsafe settings to be reset or lost. Consequently, even in extreme conditions, accidental activation of certain sequences is not possible, thereby preventing catastrophic results. Additionally, if all failsafe systems are programmed in software, it is possible for programming errors or glitches to occur. With the present invention, this problem is minimized, as the plant manager, chemist, or similarly skilled personnel physically programs the switches based on diagrams and experience.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic view of a control system of the present invention with a three-way pilot solenoid valve.

FIG. 2 is a schematic view of a control system of the present invention with a two-way direct acting solenoid.

FIG. 3 is a perspective view of representative switches mounted on a printed circuit board with shunt contact assemblies inserted on the respective switches which are used in the control systems of FIGS. 1 and 2.

FIG. 4. is an enlarged perspective view of the representative switches with shunt contact assemblies inserted on the respective switches of FIG. 3.

FIG. 5 is an enlarged cross-section view, taken along line 5-5 of FIG. 4, showing a respective switch with a respective shunt contact assembly inserted thereon.

### DETAILED DESCRIPTION OF THE INVENTION

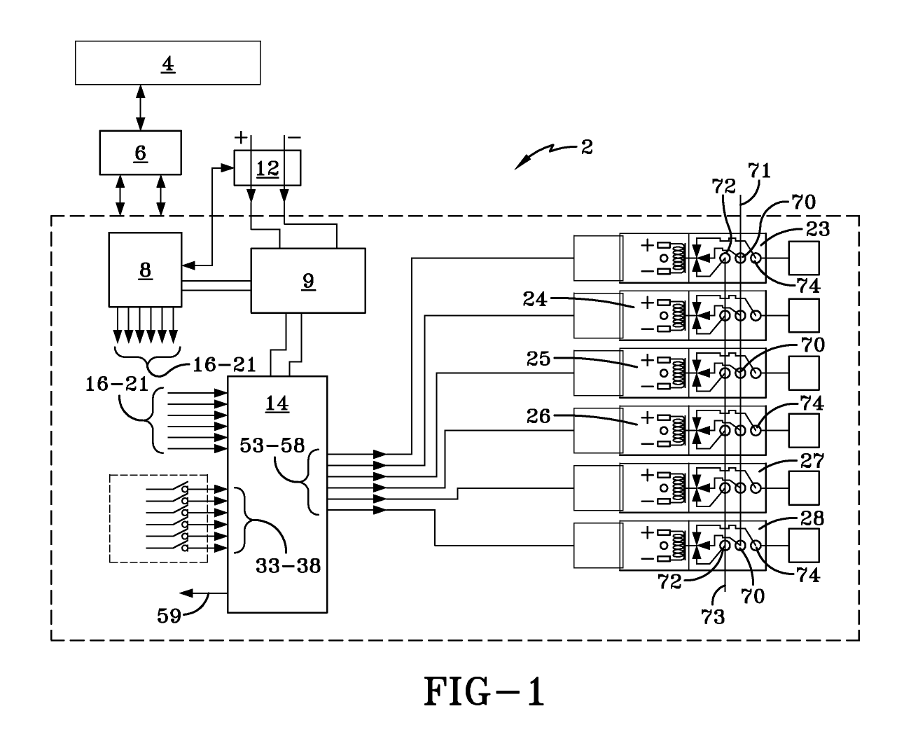

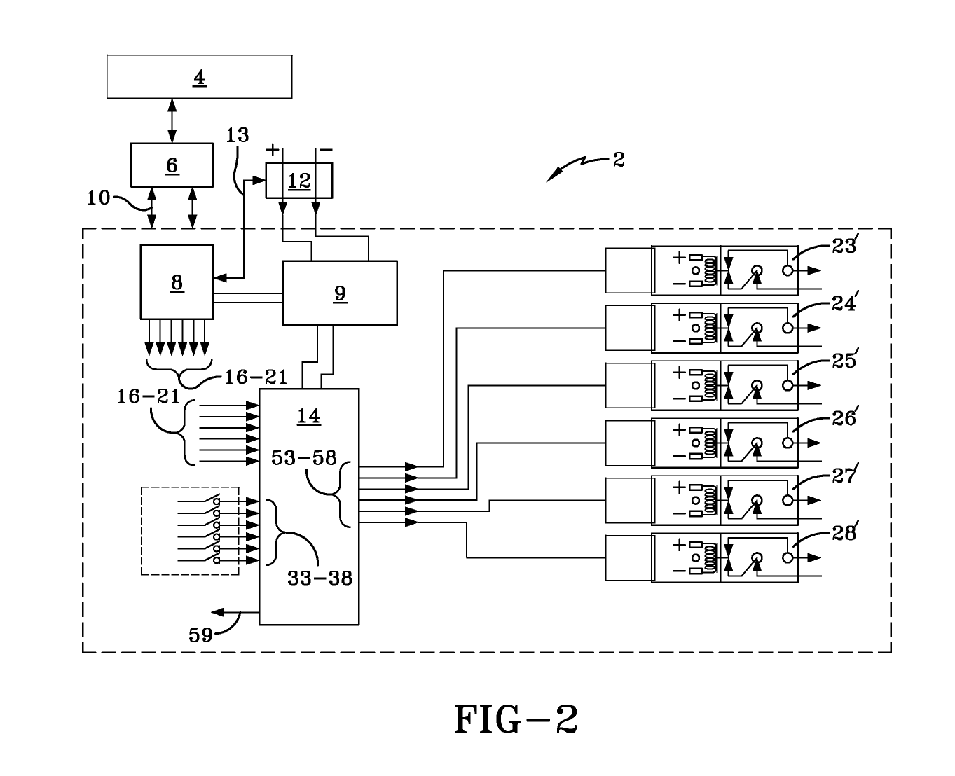

Referring to FIGS. 1 and 2, a schematic of a valve control system 2 is shown. The valve control system can be used to control the flow of materials in many industrial settings, including, but not limited to semi-conductor processing plants and chemical plants. Particularly in facilities in which accidental mixing of components can create unsafe conditions, it is essential that the valve control systems have redundant safeguards to prevent the accidental actuation of a sequence of valves which can create the unsafe conditions. In the embodiment shown, the control system is used to control the operation of valves. FIG. 1 shows the valve control system 2 used to control a three-way pilot solenoid valve, while FIG. 2 shows the control system used to control a two-way direct-acting solenoid. The control system may also be used to control other devices or processes in other environments such as manufacturing plants, aircrafts, power generation facilities, etc., in which it is important to have safeguards to prevent accidental sequences which would create unsafe conditions.

In the embodiments shown in FIGS. 1 and 2, a first controller 4 (which is part of the plant automation control system), programmed to perform certain operations, is in communication with various components of the plant automation control system, such as sensors (not shown) positioned about the plant. The first control unit or controller 4 can be a programmable logic controller (“PLC”), personal computer or other similar type of device. In response to information received from the sensors, the first controller 4, which is generally positioned at the plant level, outside of the valve control system, analyzes the information and, when required, sends digital input/output (“I/O”) commands, as represented at 6, to the second control unit or microprocessor 8. The digital commands are communicated by means of a serial or digital bus 10. In the embodiment shown, the microprocessor 8 is a component of a valve control system 2.

The microprocessor 8 also receives input from a current sensing mechanism 12. The current sensing mechanism 12 can be positioned immediately adjacent to the microprocessor 8 or can be positioned remotely, outside of the valve control system 2, so long as a communication link 13 is provided. The link can be either analog or digital. The current sensing mechanism 12 detects the presence or absence of appropriate current and communicates the same to the microprocessor 8.

A power conditioning device 9 receives electrical current from an outside source. Power conditioning devices 9 are known in the industry and are provided to eliminate voltage spikes, etc. and to provide the appropriate current to both the microprocessor 8 and the logic array 14.

The microprocessor 8 receives the input from the first controller 4 and the current sensing mechanism 12. Upon confirmation of the presence of appropriate power, the microprocessor 8 processes the signals received from the first controller 4 and sends corresponding signals 16-21 to the logic array 14 via digital pathways. In the embodiment shown, each digital pathway conveys information which relates to respective valves 23-28 or 23′-28′. The signals sent by the microprocessor 8 provide information regarding the operation of the valves, i.e., whether they should be opened or closed. While the microprocessor 8 does not send continuous signals, signals are sent at intervals calculated by the microprocessor 8 to properly control the operation of the valves 23-28 or 23′-28′ and the flow of material affected thereby. While the embodiment shown has six digital pathways which relate to six valves, more or less digital pathways and valves could be used. The maximum number of valves which can be operated is directly related to the maximum number of digital pathways that are provided either from the microprocessor 8 or the logic array 14, whichever is less.

As shown in FIGS. 1 and 2, the logic array 14 has six physical gates or switches 33-38 which correspond to the number of valves 23-28 or 23′-28′. The switches 33-38 communicate with the logic array 14 via pathways 41-46. Although six switches 33-38 are shown, the number of switches in any particular system is equal to the number of valves or devices to be controlled. The gates or switches 33-38 can be of any type commonly known in the industry which can conduct electricity thereacross when in a closed position.

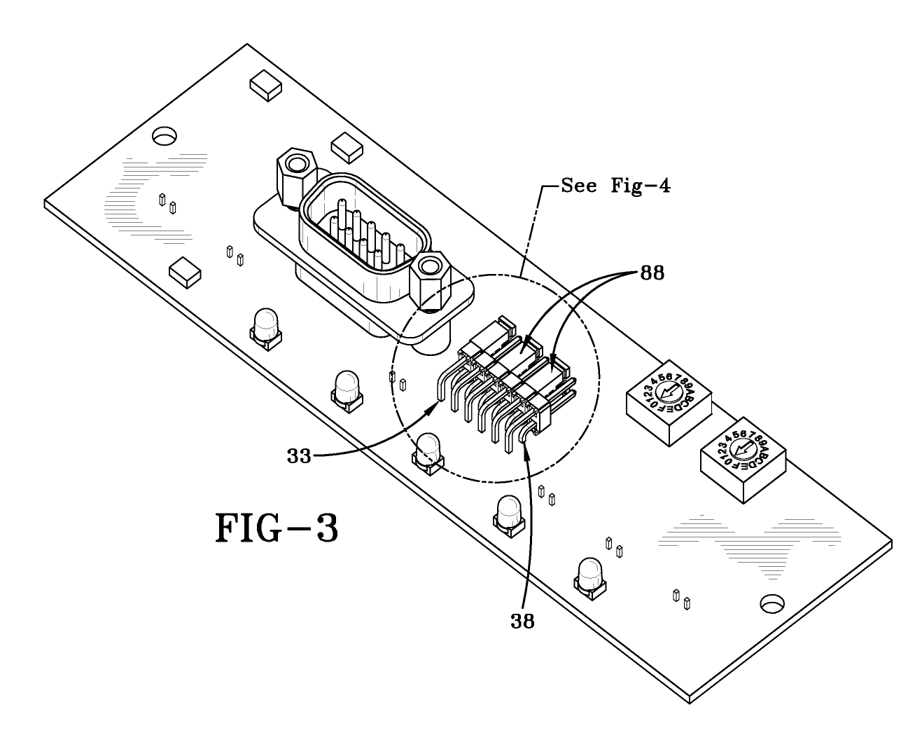

FIGS. 3, 4 and 5 illustrate an example of one embodiment of the physical switch. Each switch 33-38 has two terminals 80, 81 which are spaced apart and extend through plated through holes of a printed circuit board or substrate 82. The substrate 82 may be located proximate the logic array 14 or may be removed therefrom.

In the embodiment shown, the terminals 80, 81 have mounting portions 83, 84 which extend from the substrate 82 in a direction essentially perpendicular to the plane of the substrate 82. Shunt sections 85, 86 of the terminals 80, 81 extend from the mounting portions 83, 84 in a direction which is essentially parallel to the plane of the substrate 82. The shunt sections 85, 86 of the terminals 80, 81 are positioned in respective openings of a housing 87. The housing 87 helps maintain the spacing between the terminals 80, 81 of each switch and helps to maintain the spacing of the terminals 80, 81 between the switches 33-38. The housing 87 is made of plastic or other dielectric material to maintain the terminals 80, 81 in electrical isolation from each other.

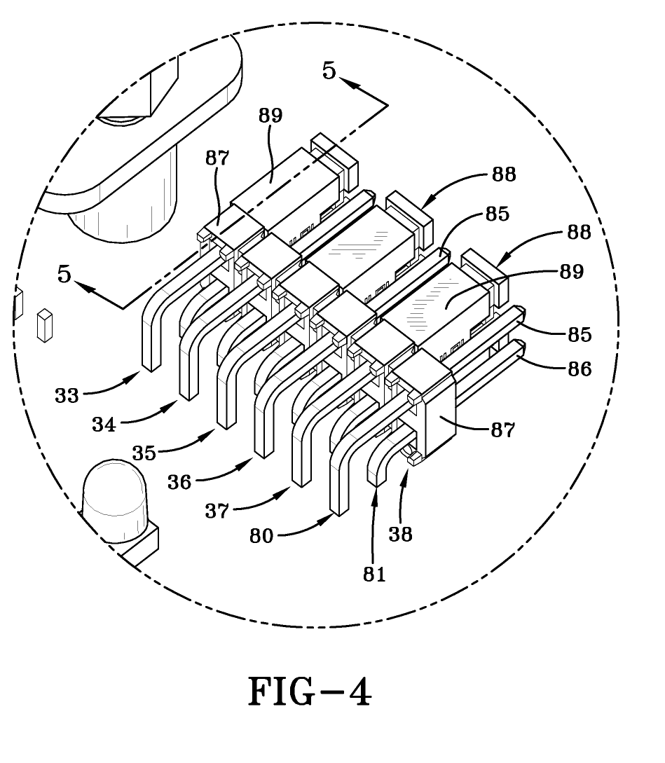

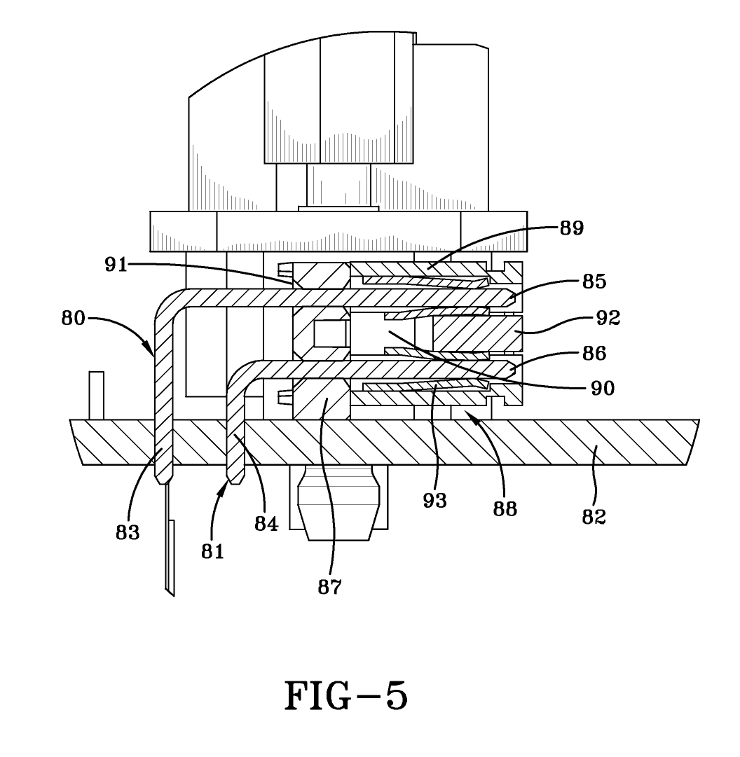

As best shown in FIGS. 4 and 5, a jumper or shunt contact assembly 88 is shown. The shunt contact assembly 88 has a housing 89 with a terminal-receiving cavity 90 extending from a front surface 91 toward a rear surface 92. A shunt contact 93 is positioned in the terminal-receiving cavity 90.

The shunt contact assemblies 88 are moved into engagement with terminals 80, 81 of respective switches. As this occurs, the shunt contact engages the shunt sections 85, 86 of terminals 80, 81 to provide an electrical path across which the current can flow. This engagement places the respective switches in a closed or selected position. The shunt contact assemblies 88 can be positioned in engagement with the terminals 80, 81 of any selected switch which is to be in the closed position.

In the embodiment shown in FIGS. 3 and 4, switches 33, 35, 37 have the shunt contact assemblies 88 positioned in engagement with the switches. Switches 33, 35, 37 are thereby placed in the selected or closed position. The remaining switches 34, 36, 38 do not have the shunt contact assemblies 88 inserted and no electrical pathway is provided. Switches 34, 36, 38 thereby remain in the nonselected or open position. For purposes of this embodiment, switches 33, 35, 37 define switch group one and switches 34, 36, 38 define switch group two. The particular configuration of the switches can vary from that shown and described herein. Many different terminals and shunt contacts are known in the industry and can be used herein without departing from the scope of the invention.

The switch configuration described in switch group one and switch group two is an illustrative example of how the switch groups may be configured. Depending upon the facility and the operation of the particular valves, devices or processes, switch group one and switch group two may be configured differently, with different switches selected or nonselected depending on the requirements of the facility.

The logic array 14 receives the signals from the microprocessor 8 via pathways 16-21. The logic array 14 also receives signals from the switches 33-38 via pathways 41-46. The logic array 14 compares the signals received from the microprocessor 8 to the signals received from the switches 33-38. In the embodiment shown in FIG. 1, if the signals from the microprocessor 8 indicate that any or all of the valves 23, 25, 27 associated with switch group one 33, 35, 37 are to be open and all of the valves 24, 26, 28 associated with switch group two 34, 36, 38 are to be closed, the logic array 14 will send the corresponding signals via outbound valve pathways 53-58 to operate valves 23-28 accordingly. Likewise, if the signals from the microprocessor 8 indicate that any or all of the valves 24, 26, 28 associated with switch group two 34, 36, 38 are to be open and all the valves 23, 25, 27 associated with switch group one 33, 35, 37 are to be closed, the logic array 14 will send the corresponding signals via outbound valve pathways 53-58 to operate valves 23-28 accordingly.

However, if the signals received from the microprocessor 8 indicate that one or more of the valves 23, 25, 27 associated with switch group one 33, 35, 37 are to be open and one or more valves 24, 26, 28 associated with switch group two 34, 36, 38 are to be open simultaneously, the logic array will not send corresponding signals via the outbound valve pathways 53-58 but will send a fault signal to the microprocessor 8 via fault output 59 and will maintain the valves in the last valid setting. As the two switch groups are mutually exclusive, this hardware failsafe option prevents accidental actuation of improper combinations.

The operation of the valve control system 2 of this application, including the use of the physical switches 33-38 and the interaction with the logic array 14 is different than is known in the prior art. In previous application the microprocessor 8 would directly control the operation of the valves 23-28 in dependence on the input signals 6 received from first controller 4, thereby increasing the likelihood of actuation of an improper sequence, as no redundant safeguards are present. Alternatively in previous applications, the control outputs 16-21 from the microprocessor 8 would not be directly connected to the valves 23-28 but would be connected in series with a software-based safety monitor. The monitor would receive the outputs from the microprocessor and check the outputs against stored information in the memory of the monitor to determine whether the outputs from the microprocessor are as expected. If the outputs were not expected, the monitor could itself initiate a control function to eliminate any potentially dangerous situation. If the safety monitor disagreed with the outputs, then it would typically open all relay contacts and initiate a plant shutdown. While the use of the monitor allows the plant to be shut down if the microprocessor sends improper signals, the safety monitor is programmable software, susceptible to programming errors, corrupt files, power failures or surges and the like, just like any other software. Consequently, the safety monitor reduces the risk of actuation of an improper sequence, if it does not eliminate the possibility.

Referring to FIG. 1, appropriate signals, as determined by the logic array 14, are sent via outbound valve pathways 53-58 to respective three-way pilot solenoid valves 23-28. Each solenoid valve 23-28 has shunt diodes, varistor surge protection, and solenoid coils encapsulated in a potting compound or plastic. The shunt diode may be a zener diode to permit current in the forward direction and in the reverse direction if the voltage is larger than the breakdown voltage.

The shunt diode, varistor surge protection and solenoid coils translate the signal received from the outbound valve pathways to operate the appropriate air inlet pilot valves 70 of the common air inlet 71, the air outlet pilot valves 72 of the common vent outlet 73, and the actuation valves 74. The actuation valves 74 are connected to the pneumatic valves, which control the flow of the chemicals or other material.

Referring to FIG. 2, appropriate signals, as determined by the logic array, are sent via outbound valve pathways 53-58 to respective two-way direct-acting solenoid valves 23′-28′. The solenoid valves 23′-28′ have shunt diodes, varistor surge protection, and solenoid coils to translate the signals received from the outbound valve pathways to operate the solenoid valves 23′-28′.

The three-way pilot solenoid valves and two-way direct-acting solenoid valves are provided for illustrative purposes. The use of a control system with physical gates or switches is not limited to the use with the valve described. The control system may be used in any circumstance in which the actuation of improper sequences can cause unsafe conditions, such as in the operation of automated machinery, etc.

The use of physical switches 33-38 in a computerized control system has many advantages. Several of these advantages relate to safety. As the switches are physical, hardware switches, a power surge, etc. will not cause the failsafe settings to be reset or lost. Consequently, even in extreme conditions, accidental activation of certain sequences is not possible, thereby preventing catastrophic results.

Additionally, if all failsafe systems are programmed in software, it is possible for programming errors or glitches to occur. With the present invention, this problem is minimized, as the plant manager, chemist, or other skilled personnel physically connects the switches based on diagrams and experience.

This type of physical failsafe control system can be of great benefit in many applications, including in chemical plants, where improper mixing of the chemicals can result in explosions and/or death and in nuclear plants where the proper flow of water can prevent a core meltdown.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A valve control system which receives control information generated from reference information received from system sensors of physical parameters, the control system comprising:
a plurality of valves;
a control device which receives the control information and generates valve control output information, indicating which valves should be operated;
a plurality of physical switches, each of the switches represents one of the plurality of valves, a first group of selected switches are closed and a second group of nonselected switches are open,
a logic array which receives the valve control output, the logic array compares the valve control output with the first group of selected switches or the second group of nonselected switches, the logic array generates valve operation output;
wherein if the valve control output indicates that at least one valve associated with the first group of selected switches and at least one valve associated with the second group of nonselected switches are to be in an open position at the same time, the logic array will not send the valve operation output to the valves and will send an error message to the control unit.

2. The valve control system as recited in claim 1 wherein if the valve control output indicates that only valves associated with the first group of selected switches or only valves associated with the second group of nonselected switches are to be in an open position at the same time, the logic array will send the valve operation output to the valves.

3. The valve control system as recited in claim 1 wherein the logic array remains at the last valid setting when an error message is sent to the control unit.

4. The valve control system as recited in claim 1 wherein the control device is a microprocessor.

5. The valve control system as recited in claim 1 wherein the control information is processed by a controller and sent to the control device.

6. The valve control system as recited in claim 1 wherein the first group of selected switches having terminals which are spaced apart and are positioned on a printed circuit board.

7. The valve control system as recited in claim 6 wherein shunt contact assemblies are moved into engagement with the terminals of the first group of selected switches, whereby shunt contacts of the shunt contact assemblies engage the terminals of the first group of selected switches to place the respective switches in the closed position.

8. A valve control system which receives control information generated from reference information received from system sensors of physical parameters, the control system comprising:
a plurality of valves;
a control device which receives the control information and generates valve control output information, indicating which valves should be operated;
a plurality of physical switches, each of the switches represents one of the plurality of valves, a first group of selected switches are closed and a second group of nonselected switches are open,
a logic array which receives the valve control output, the logic array compares the valve control output with the first group of selected switches or the second group of nonselected switches, the logic array generates valve operation output;
wherein if the valve control output indicates that only valves associated with the first group of selected switches or only valves associated with the second group of nonselected switches are to be in an open position at the same time, the logic array will send the valve operation output to the valves.

9. The valve control system as recited in claim 8 wherein if the valve control output indicates that at least one valve associated with the first group of selected switches and at least one valve associated with the second group of nonselected switches are to be in an open position at the same time, the logic array will not send the valve operation output to the valves and will send an error message to the control unit.

10. The valve control system as recited in claim 9 wherein the logic array remains at the last valid setting when an error message is sent to the control unit.

11. The valve control system as recited in claim 10 wherein the control device is a microprocessor.

12. The valve control system as recited in claim 8 wherein the control information is processed by a controller and sent to the control device.

13. The valve control system as recited in claim 8 wherein the first group of selected switches having terminals which are spaced apart and are positioned on a printed circuit board.

14. The valve control system as recited in claim 13 wherein shunt contact assemblies are moved into engagement with the terminals of the first group of selected switches, whereby shunt contacts of the shunt contact assemblies engage the terminals of the first group of selected switches to place the respective switches in the closed position.

15. A control system which receives control information generated from reference information received from system sensors of physical parameters, the control system controls a plurality of control devices, the control system comprising:
a control unit which receives and processes the control information and generates control device output, indicating which control devices should be operated;
a plurality of physical switches, each of the switches represents one of the plurality of control devices, a first group of selected switches are closed and a second group of nonselected switches are open,
a logic array which receives the control device output, the logic array compares the control device output with the first group of selected switches or the second group of nonselected switches, the logic array generates control device operation output;
wherein if the control device output indicates that at least one control device associated with the first group of selected switches and at least one control device associated with the second group of nonselected switches are to be engaged at the same time, the logic array will not send the control device operation output to the control devices and will send an error message to the control unit.

16. The control system as recited in claim 15 wherein if the control device output indicates that only control devices associated with the first group of selected switches or only control devices associated with the second group of nonselected switches are to be engaged at the same time, the logic array will send the control device output to the control devices.

17. The control system as recited in claim 15 wherein the logic array remains at the last valid setting when an error message is sent to the second control unit.

18. The control system as recited in claim 15 wherein the control unit is a microprocessor.

19. The control system as recited in claim 15 wherein the control devices are valves.

20. The control system as recited in claim 15 wherein the first group of selected switches having terminals which are spaced apart and are positioned on a printed circuit board, shunt contact assemblies are moved into engagement with the terminals of the first group of selected switches, whereby shunt contacts of the shunt contact assemblies engage the terminals of the first group of selected switches to place the respective switches in the closed position.
